(19) United States
(12) Patent Application Publication
(10) Pub. No.: US 2011/0165486 A1
(43) Pub. Date: Jul. 7, 2011

(54) METHOD AND A CONTROL ARRANGEMENT FOR A FUEL CELL DEVICE

(75) Inventors: Tero HOTTINEN, Lohja (FI); Timo LEHTINEN, Espoo (FI)

(73) Assignee: Wartsila Finland Oy, Vaasa (FI)

(21) Appl. No.: 12/986,581

(22) Filed: Jan. 7, 2011

Related U.S. Application Data
(63) Continuation of application No. PCT/FI2009/050503, filed on Jun. 11, 2009.

(30) Foreign Application Priority Data
Jul. 10, 2008 (FI) 20085718

(51) Int. Cl. H01M 8/04

(52) U.S. Cl. 429/431

(57) ABSTRACT

The disclosure relates to a fuel cell device arrangement for producing electrical energy, having at least one fuel cell anode and cathode, an electrolyte for conveying ions between the anode and the cathode, and a passage separate from the electrolyte for the electrons travelling from the anode to the cathode. A control arrangement can prevent the formation of carbon by calculating a thermodynamic equilibrium model based on thermodynamic equilibriums of chemical reactions for the feedback recirculation of fuel. Measurement values are obtained, at least from the electric current and the fuel flow rate, for calculating the fuel composition. Conversion values set on the basis of the thermodynamic equilibrium model for the fuel are calculated using the measurement values and fuel composition. The calculation can be repeated to produce the conversion values by which the fuel composition can be determined to converge with sufficient accuracy, so that operation of the fuel cell device can remain within safety limits according to the thermodynamic equilibrium model.

### RELATED APPLICATIONS

This application claims priority as a continuation application under 35 U.S.C. §120 to PCT/F12009/050503 (WO 2010 004083) which was filed as an International Application on Jun. 11, 2009 designating the U.S., and which claims priority to Finnish Application 20085718.5 filed in Finland on Jul. 10, 2008. The entire contents of these applications are hereby incorporated by reference in their entireties.

### FIELD

Fuel cells are electrochemical devices supplied with reactants for producing electrical energy.

### BACKGROUND INFORMATION

FIG. 1 shows a fuel cell comprising an anode side 100 and a cathode side 102 and an electrolyte 104 between them. The reactants fed to the fuel cell devices undergo a process in which electrical energy and water are produced as a result of an exothermal reaction. In solid oxide fuel cells (SOFCs), oxygen fed to the cathode side receives an electron from the cathode, that is, is reduced to a negative oxygen ion which travels through the electrolyte to the anode where it combines with the fuel used, producing water and carbon dioxide. Between the anode and the cathode is an external electric circuit through which electrons are delivered to the cathode.

Natural gases such as methane and gases containing higher carbon compounds have been used as fuels in SOFCs, which gases, however, are preprocessed before feeding to the fuel cells to prevent carbon formation (i.e., coking). In coking, hydrocarbons decompose thermally and produce carbon which adheres to the surfaces of the fuel cell device and adsorbs on catalysts, such as nickel particles. The carbon produced in coking coats some of the active surface of the fuel cell device, and can significantly deteriorate the reactivity of the fuel cell process. The carbon may even completely block the fuel passage.

Preventing coking is, therefore, desireable for ensuring a long service life for the fuel cells. The prevention of coking also saves catalysts, that is, the substances (nickel, platinum, etc) used in fuel cells for accelerating reactions. Gas preprocessing involves water, which is supplied to the fuel cell device. The water produced in combining the oxygen ion and the fuel, that is, the gas on the anode may also be used in the preprocessing of the gas.

The composition of the gas recirculated through the anode in feedback arrangement should be known with sufficient accuracy for the known preprocessing of the gas to be successful. Especially the oxygen/carbon (0/C) ratio, and to some extent also the hydrogen/carbon (H/C) ratio, should be controlled to avoid the riskiest reaction environment for carbon formation.

The preprocessing of the gas involves the use of a complex and costly online measuring arrangement, such as a gas chromatogram, for determining the constituents of the gas to be recirculated, in order to ensure the execution of the preprocessing of the gas in an appropriate manner for the process.

### SUMMARY

A fuel cell device arrangement for producing electrical energy is disclosed, comprising at least one fuel cell anode and cathode, an electrolyte for conveying ions between the anode and the cathode, a passage separate from the electrolyte for electrons travelling from the anode to the cathode, calculation means for calculating at least one thermodynamic equilibrium model based on thermodynamic equilibriums of chemical reactions, means for recirculating fuel in a feedback arrangement through the fuel cell anode, for producing measurement values at least from electric current and fuel flow rate of the recirculating fuel, and for calculating a composition of the fuel for calculating a conversion value based on the thermodynamic equilibrium model for the fuel using said measurement values and fuel composition, and a control arrangement for addressing carbon formation, the control arrangement including means for detecting when a specified change takes place in at least one of the fuel flow rate and electric current, and for recalculating the conversion value for determining a convergence of the fuel composition calculation to a desired accuracy such that the fuel cell device will operate within safety limits according to the thermodynamic equilibrium model.

A method for producing electrical energy by fuel cell technology is disclosed, the method comprising conveying ions through an electrolyte between an anode and a cathode of a fuel cell, conveying electrons from the anode to the cathode via a passage separate from the electrolyte, calculating at least one thermodynamic equilibrium model based on thermodynamic equilibriums of chemical reactions, recirculating fuel in a feedback arrangement through the fuel cell anode by producing measurement values at least from electric current and fuel flow rate, by calculating fuel composition, and by calculating a conversion value based on the thermodynamic equilibrium model for the fuel to be recirculated using the measurement values and fuel composition, detecting when a specified change takes place in at least one of the fuel flow rate and electric current through measurement values of fuel flow rate and electric current, and repeating the calculation to produce the conversion value for determining a convergence of the fuel composition calculation to a desired accuracy, for causing the fuel cell device to operate within safety limits according to the thermodynamic equilibrium model.

### BRIEF DESCRIPTION OF THE DRAWINGS

Exemplary embodiments of the disclosure will be described with reference to the figures. The disclosure is not, however, limited to the description and figures, but may be modified according to limits specified in the accompanying claims. In the figures:

FIG. 1 shows an implementation according to a known fuel cell; and

FIG. 2 shows an implementation of a fuel cell device according to an exemplary embodiment disclosed herein.

### DETAILED DESCRIPTION

A fuel cell implementation is disclosed which can be maintained within safe operating limits without a complex and costly continuous measuring arrangement. This can be achieved by means of a fuel cell device arrangement for producing electrical energy, comprising at least one fuel cell anode and cathode, an electrolyte for conveying ions between the anode and the cathode, and a passage separate from the electrolyte for the electrons travelling from the anode to the cathode. A control arrangement is used for addressing, (e.g., preventing) the formation of carbon, and comprises means for calculating at least one thermodynamic equilibrium based on the thermodynamic equilibriums of chemical reactions for the feedback recirculation of fuel, and means for implementing recirculation by recirculating fuel in a feedback arrangement through the fuel cell anode, for producing measurement values in recirculation at least from the electric current and the fuel flow rate, for determining the composition of the fuel through calculation, for calculating the conversion values set on the basis of the thermodynamic equilibrium model for the fuel to be recirculated by using the measurement values and fuel composition, and where desired, for repeating the calculation to produce the conversion values by which the calculation of the fuel composition can be determined to converge with sufficient (i.e., desired, or specified) accuracy. Using the conversion values, the operation of the fuel cell device can be set to remain within safety limits according to the thermodynamic equilibrium model.

The disclosure also relates to a method for producing electrical energy by fuel cell technology. In an exemplary method, ions are conveyed through an electrolyte between the anode and the cathode of the fuel cell and electrons are conveyed from the anode to the cathode via a passage separate from the electrolyte. In the method, the following stages can be carried out to prevent the formation of carbon: one or more thermodynamic equilibrium models based on the thermodynamic equilibriums of chemical reactions are calculated for the feedback recirculation of fuel and recirculation of the fuel is carried out in a feedback arrangement through the fuel cell anode by producing measurement values in recirculation at least from the electric current and fuel flow rate, by determining the composition of the fuel through calculation, by calculating the conversion values set on the basis of the thermodynamic equilibrium model for the fuel to be recirculated by using the measurement values and fuel composition, and where desired, by repeating the calculation for producing the conversion values by means of which the calculation of the fuel composition can be determined to be converged with sufficient accuracy. Using the conversion values, the operation of the fuel cell device can be set to remain within safety limits according to the thermodynamic equilibrium model.

The disclosure is based, at least in part, on the fact that on the basis of the thermodynamic equilibrium of the fuel cell process and the desired ratio between oxygen and carbon the thermodynamic equilibrium models of various chemical reactions are calculated, setting at least the values of the electric current and the fuel flow rate as known values. The composition of the fuel is determined through calculation. The equilibrium models are utilised in the feedback recirculation of fuel in the fuel cell process, where, based on the measurement values produced for at least the fuel flow rate and the electric current, and on the fuel composition determined through calculation, and one or more thermodynamic equilibrium models, through calculation, the operational mode of the fuel cell process can be found in which it remains within the set safety limits.

Exemplary implementations according to the disclosure make possible safe recirculation of fuel in a feedback arrangement without requiring a separate water supply, at the same time increasing the utilisation rate of the fuel, that is, improving the efficiency of electrical energy production in the fuel cell process. Another exemplary advantage is that the safe use of the fuel cell device, where coking is prevented, is possible in an implementation which does not require using a complex and costly continuous online measuring arrangement, such as a gas chromatogram.

Fuel cells are electrochemical devices which can be used to produce electrical energy with high efficiency and in an environmentally friendly manner. Fuel cell technology is considered one of the most promising future forms of energy production.

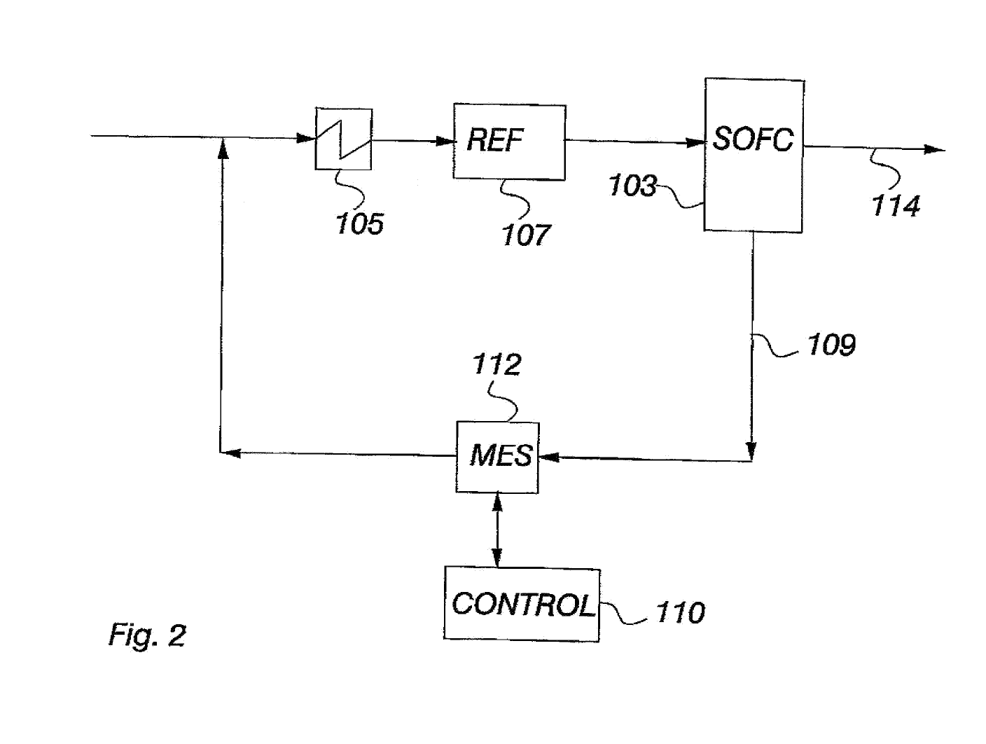

An exemplary embodiment of the disclosure relates to a SOFC device, that is, a Solid Oxide Fuel Cell device. FIG. 2 shows a SOFC device according to a exemplary embodiment of the disclosure, which may utilise, for example, natural gas, biogas or methanol or other compounds containing hydrocarbons, as its fuel.

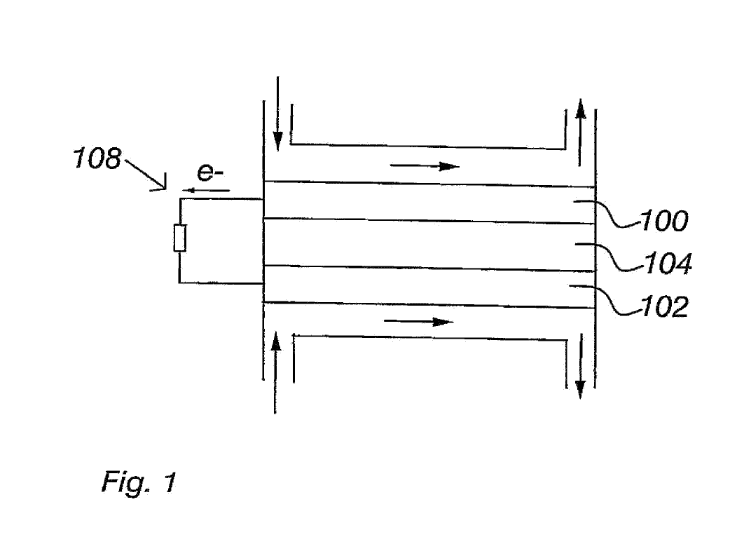

The fuel cell device arrangement shown in FIG. 2 comprises plate-like fuel cells, each fuel cell comprising an anode 100 and a cathode 102 as show in FIG. 1, and in FIG. 2 the fuel cells are assembled in stack formation 103 (SOFC stack). The fuel is recirculated in feedback arrangement through the anode. Between the fuel cell anode and cathode is an electrolyte 104. To the cathode side 102 is supplied oxygen which receives an electron from the cathode, that is, is reduced to a negative oxygen ion, which travels through the electrolyte to the anode, where the oxygen ion combines with the fuel used and gives off water and carbon dioxide. Between the anode and the cathode is a separate passage 108, that is, an external electric circuit through which electrons, that is, an electric current, travels through the load to the cathode.

The fuel cell device arrangement shown in FIG. 2 comprises a fuel heat exchanger 105 and a reformer 107. Heat exchangers are used for controlling the heat balance of the fuel cell process and there may be several of them at different locations in the fuel cell device. The excess heat energy in the recirculated gas is recovered in the heat exchanger for use elsewhere in the fuel cell device or in the district heating network. The heat exchanger recovering the heat may thus be at a different location than that shown in FIG. 2. The reformer is a device which converts fuel, such as natural gas, into a form suitable for fuel cells, that is, for example into a gas mixture containing one half of hydrogen and the rest methane, carbon dioxide and inert gases. The reformer is not, however, necessary in all fuel cell implementations, but untreated fuel may also be fed directly to the fuel cells 103.

Only a part of the fuel burned on the fuel cell 103 anodes 100 is recirculated through the anodes in a feedback arrangement and FIG. 2, therefore, shows diagrammatically the exhaustion 114 of the remainder of the fuel from the anodes 100.

The use of the fuel cell device according to the exemplary embodiment of the disclosure shown in FIG. 2 comprises a control arrangement for preventing carbon formation, the arrangement comprising as calculation means 110 a computer for calculating one or more equilibrium models based on the thermodynamic equilibriums of chemical reactions for the feedback 109 recirculation of the fuel through the anode 100. The calculation process may be carried out in connection with the fuel cell process by means of a control computer 110, which is, for example, a programmable logic (PLC, Programmable Logic Controller) or other processor-based computer. The calculation process may also be carried out as an advance calculation on the computer's processor which may be located elsewhere than the fuel cell device itself.

By means for implementing an advance calculation process, thermodynamic equilibrium curves of the process may be produced in the form of thermodynamic equilibrium models. This type of calculation may be relatively slow and involve much of the computer's processing capacity, which computer may be situated, for example, in the product development department of a fuel cell manufacturing company.

The calculation process is based, at least in part, on the fact that in the calculation of an electricity-producing fuel cell process, the electric current and the flow rate of water, which is included in fuel cell devices with separate external water supplies, are given as known values. It is not necessary to give the temperature of the fuel cell process as a known value due to the high operating temperatures of the fuel cell devices according to the exemplary embodiments disclosed herein. Another known value is the flow rate of the fuel, for example natural gas; for example the total flow rate of recirculation. For different chemical reactions, at each temperature, a thermodynamic equilibrium curve can be found to serve as a thermodynamic equilibrium model.

In the operation of the fuel cell device according to the exemplary embodiment, essential reactions are, for example, the reduction of oxygen into a negative oxygen ion on the cathode and the combination of the oxygen ion with the fuel used on the anode, which gives off water and carbon dioxide. Ready-made values can be found in literature for some of the optimal values for the content ratio between oxygen and carbon at different temperatures in the fuel cell device process, which the formation of carbon is minimised. In literature, calculation methods are known by which can be calculated other optimal values for the content ratio of oxygen and carbon for different fuel compositions. In a fuel cell process, it can be important to maintain the flow rate of the quantity of water sufficiently high to ensure that the process remains outside the carbon formation area. The calculation process carried out either as advance calculation or in real time with the fuel cell process can be done by using the given known values in the calculation for calculating a thermodynamic equilibrium model for the chemical reactions of the fuel cell process at known temperatures. In advance calculation, equilibrium curves can be produced for various flow values, such as recirculation flow values. Calculating several equilibrium curves is not, however, necessary for implementations according to the disclosure to be successful.

In a calculation process according to an exemplary embodiment, a three-dimensional (3D) matrix is formed by advance calculation, where the supply flow of water, the supply flow of fuel and the electric current are the x, y and z axes, and the mass percentages of the components produced in the chemical reactions are the x, y and z axes' elements in the matrix. To reduce the number of variables and the dimensions of the matrix, a polynome, for example, may be applied to the result data for use in the system calculation. In this way sufficiently accurate control data can be produced for operating the fuel cell device according to an exemplary embodiment, and make possible real-time calculation using a control computer 110. Applying a polynome to the result data also makes it possible to eliminate the electric current from the 3D matrix, which is a factor that can affect the fuel cell process through a momentary effect. However, when the thermodynamic equilibrium model is calculated in the real-time of the fuel cell process, the forming of the three-dimensional matrix need not be performed.

In an exemplary implementation, a control computer 110 can be used as means for realising recirculation, on which computer are recorded the thermodynamic equilibrium curves produced by advance calculation or by means of which is calculated the thermodynamic equilibrium model in the real time of the fuel cell process. The means for realising recirculation 110, 112 by recirculating fuel in a feedback arrangement and by measuring with the measuring means 112 can produce measurement values of the fuel flow rate, the electric current, and possibly also of the water flow rate, temperature and other factors. The specified information on the composition of the fuel, such as the content ratio between oxygen and carbon, can be determined through calculation by the control computer 110.

At the following stage, the control computer 110 is used to calculate the changed values to be set on the basis of a real-time thermodynamic equilibrium model or an advance calculation equilibrium curve for the recirculated fuel by using the measurement values and the calculated oxygen/carbon ratio. The calculation is repeated through iteration until a converged status is reached, where the calculation of the composition of the fuel can be found converged with sufficient accuracy, that is, the oxygen/carbon ratio of the fuel circulating to the fuel cells in feedback arrangement no longer changes in calculation. In the first or several iteration calculations, changed values are thus produced by which the composition of the fuel may be set to be converged during the operation of the fuel cell device, that is, into operation remaining within the safety limits according to the thermodynamic equilibrium model or equilibrium curve. In this operation, the oxygen/carbon content ratio of the fuel remains at its desired value with substantial accuracy.

Measuring the electric current can correspond, in practice, to measuring the amount of oxygen ions, that is, the oxygen flux. The measuring means 112 for the implementation according to an exemplary embodiment of the disclosure can thus be inexpensive devices representing basic measuring technology, such as a flow meter, a current meter and a temperature meter, which are in any case used in connection with a fuel cell device. The information of the fuel composition can include the oxygen/carbon ratio, which is calculated at the conversion stage on the basis of predetermined safety limits. The time difference between fuel circulations may be, for example, only 20 ms (or lesser or greater).

When the temperature of the fuel cell process changes, the operation of the fuel cell device can be adjusted, using the control computer 100 by a new conversion stage, to a thermodynamic equilibrium curve or equilibrium model complying with the new, changed temperature. In an exemplary embodiment of the disclosure this is not, however, necessary due to the high operating temperatures of the SOFC fuel cell devices. Rather, a new conversion stage comes into question with a SOFC when a change takes place in the fuel flow rate, electric current or possible externally arranged water flow rate. In this way, the operation of the flow cell device remains within the safety limits even when changes occur. The conversion stages according to the disclosure can be carried out so rapidly that they can be conducted in connection with the electrical energy production process of the fuel cell device.

An exemplary fuel cell device according to the disclosure may produce electricity with a power rating of 1 MW or less (or greater), for example, at an operating temperature of 750° C. (without, however, being limited to this temperature or power rating) and it may be connected to both the power supply system and the district heating network, which recovers the thermal energy released from the operation of the fuel cell device.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A fuel cell device arrangement for producing electrical energy, comprising:
at least one fuel cell anode and cathode;
an electrolyte for conveying ions between the anode and the cathode;
a passage separate from the electrolyte for electrons travelling from the anode to the cathode;
calculation means for calculating at least one thermodynamic equilibrium model based on thermodynamic equilibriums of chemical reactions;
means for recirculating fuel in a feedback arrangement through the fuel cell anode, for producing measurement values at least from electric current and fuel flow rate of the recirculating fuel, for calculating a composition of the fuel for calculating a conversion value based on the thermodynamic equilibrium model for the fuel using said measurement values and fuel composition;
and a control arrangement for addressing carbon formation, the control arrangement including means for detecting when a specified change takes place in at least one of the fuel flow rate and electric current, and for recalculating the conversion value for determining a convergence of the fuel composition calculation to a desired accuracy such that the fuel cell device will operate within safety limits according to the thermodynamic equilibrium model.

2. A fuel cell device arrangement as claimed in claim 1, wherein the control arrangement comprises:
means for calculating a thermodynamic equilibrium model as thermodynamic equilibrium curves produced by advance calculation.

3. A fuel cell device arrangement as claimed in claim 1, wherein the fuel consists of compounds containing hydrocarbons.

4. A fuel cell device arrangement as claimed in claim 2, wherein the control arrangement comprises:
means for calculating a thermodynamic equilibrium curve based on a desired content ratio between carbon and oxygen for addressing formation of carbon at one or more temperatures of the fuel cell.

5. A fuel cell device arrangement as claimed in claim 2, wherein the control arrangement comprises:
means for forming a three-dimensional matrix, where a supply flow of water, a supply flow of fuel and the electric current are x, y and z axes, and mass percentages of components produced in chemical reactions are elements of the x, y and z axes in the matrix.

6. A method for producing electrical energy by fuel cell technology, the method comprising:
conveying ions through an electrolyte between an anode and a cathode of a fuel cell;
conveying electrons from the anode to the cathode via a passage separate from the electrolyte;
calculating at least one thermodynamic equilibrium model based on thermodynamic equilibriums of chemical reactions;
recirculating fuel in a feedback arrangement through the fuel cell anode by producing measurement values at least from electric current and fuel flow rate, by calculating fuel composition, and by calculating a conversion value based on the thermodynamic equilibrium model for the fuel to be recirculated using the measurement values and fuel composition;
detecting when a specified change takes place in at least one of the fuel flow rate and electric current through measurement values of fuel flow rate and electric current; and
repeating the calculation to produce the conversion value for determining a convergence of the fuel composition calculation to a desired accuracy, for causing the fuel cell device to operate within safety limits according to the thermodynamic equilibrium model.

7. A method as claimed in claim 6, comprising:
calculating a thermodynamic equilibrium model by thermodynamic equilibrium curves produced by advance calculation.

8. A method as claimed in claim 6, wherein the fuel consists of compounds containing hydrocarbons.

9. A method as claimed in claim 7, comprising:
recalculating the thermodynamic equilibrium curve based on a desired content ratio between carbon and oxygen for addressing formation of carbon at one or more temperatures of the fuel cell.

10. A method as claimed in claim 7, comprising:
calculating a three-dimensional matrix where a supply flow of water, a supply flow of fuel and the electric current are x, y and z axes, and mass percentages of components produced in chemical reactions are the elements of the x, y and z axes in the matrix.
